(19) United States
(12) Patent Application Publication
(10) Pub. No.: US 2012/0293373 A1
(43) Pub. Date: Nov. 22, 2012

(54) RTLS SYSTEM USING TDO

(75) Inventor: Chang Sung YOU, Seoul (KR)

(73) Assignee: LSIS CO., LTD., Anyang-si (KR)

(21) Appl. No.: 13/465,908

(22) Filed: May 7, 2012

(30) Foreign Application Priority Data
May 16, 2011 (KR) 10-2011-0045480

(51) Int. Cl. G01S 3/02

(52) U.S. Cl. 342/465

(57) ABSTRACT

Provided is an RTLS system using TDOA, the RTLS system tracking, by a positioning unit, a position of a transmitter based on a position signal transmitted by the transmitter, the system comprising a plurality of receivers receiving the position signal from the transmitter, and a gateway calculating a time difference of position signal arriving at the plurality of receivers from the transmitter and providing the time difference to the positioning unit.

### CROSS REFERENCE TO RELATED APPLICATION

Pursuant to 35 U.S.C.§119 (a), this application claims the benefit of earlier filing date and right of priority to Korean Patent Application No. 10-2011-0045480, filed on May 16, 2011, the contents of which is hereby incorporated by reference in their entirety.

### BACKGROUND OF THE DISCLOSURE

1. Field of Endeavor

The present disclosure relates to a position tracking technology.

2. Background

This section provides background information related to the present disclosure which is not necessarily prior art.

In order to accurately locate a position of a transmitter in a conventional RTLS (Real Time Locating System), time synchronization among the receivers must be accurately realized down to a nano second. To this time synchronization, the RTLS system fundamentally requires a master receiver providing a reference time, and slave receivers wirelessly or wiredly receive a reference time from the master receiver and synchronize own time, where the time synchronization among receivers is realized through message exchange.

In order to achieve a high precision time synchronization down to a nano second, wireless time synchronization methods have been conventionally proposed using a wired environment using an optical cable or an additional system using a highest master, a master and a bridge. One of the technologies is a time synchronization method using TDOA (Time Difference of Arrival).

In the conventional TDOA-based RTLS system, receivers positioned about a transmitter receive signals transmitted by the transmitter, and received data and arrival time information of the receivers are transmitted to a location engine of a server. The location engine receives the data and the arrival time information from each receiver to calculate a position of the transmitter through TDOA.

A typical TDOA system uses a number of spatially separate transmitters which are synchronized in time. Each transmitter transmits an identifiable pulse chain. The time difference between the arrivals of the pulse chains from the different stations enables time difference of arrival hyperboles to be calculated for each pair of stations. A portion can be calculated from two intersecting hyperboles provided the positions of the transmitters are known. However, this system does not take into account multi-path effects or signal propagation differences. Additionally, the TDOA measurement system typically requires synchronous clock signals on all devices through, for example, a wired method using an optical communication making them prohibitively complicated and expensive, in which high priced devices and additional systems are required.

FIGS. 1 and 2 are schematic conceptual views illustrating a conventional TDOA-based RTLS system, where FIG. 1 illustrates a time synchronization of a reception period using an optical communication network, and FIG. 2 illustrates a time synchronization of a reception period using a wireless communication network. FIG. 3 illustrates an exemplary detailed configuration of FIG. 1.

Referring to FIG. 1, a conventional wired RTLS system includes an RTLS transmitter 100, an RTLS receiver 200, an RTLS location engine 300 and a pulse generation module 400 for time synchronization.

The transmitter 100 using the TDOA transmits a position signal including its own position information to the receiver 200, the receiver 200 receives a message from the transmitter 100, records a point where the message is received (based on a synchronous clock signal generated by the pulse generation module 400), and transmits to the location engine 300 using various communication networks (e.g., Ethernet) (TDOA backhaul). The location engine receives the position signal transmitted by the transmitter 100 (TDOA backhaul) and calculates a position of the transmitter 100 using the TDOA.

TDOA from a pair of receivers 200 generates a pair of hyperbolas constant in a distance difference with the receiver 200 as a vertex. An intersection of these hyperbolas is estimated as a position of a tag. Thus, the position of the transmitter 100 is estimated by at least three pieces of TDOA information.

In order to maintain a nano-second resolution in the conventional RTLS system thus described, optical paths as many as the number of receivers 200, a synchronization module 230 configured inside the receiver 200 and a communication module 240 for transmitting the message of the receiver 200 to the location engine 300 are required.

Furthermore, each receiver 200 uses an independent oscillator such that the RTLS system requires a plurality of oscillators (not shown). In this case, each receiver 200 operates in response to an independent clock, whereby a problem arises of generating a clock drift.

In order to solve the problems under the wired environment, an RTLS system of wireless environment has been considered as shown in FIG. 2. However, problems still exist that requires an additional system causing a clock drift because each of the receivers 200 must be formed with a time synchronization transceiver 250.

It is, therefore, desirable to overcome the above problems and others by providing an RTLS system using TDOA simplified in structure and capable of calculating an accurate time difference.

### SUMMARY OF THE DISCLOSURE

This section provides a general summary of the disclosure, and is not a comprehensive disclosure of its full scope or all of its features.

The present disclosure has been made to solve the foregoing problem(s) of the prior art, and therefore an object of certain embodiments of the present invention is to provide an RTLS system using TDOA configured to simplify an RTLS system by calculating an accurate time difference of arrival of a signal from a transmitter in a gateway existing in a position location group unit.

In one general aspect of the present disclosure, there is provided a real-time RTLS system tracking, by a positioning unit, a position of a transmitter based on a position signal transmitted by the transmitter, the system comprising: a plurality of receivers receiving the position signal from the transmitter; and a gateway calculating a time difference of position signal arriving at the plurality of receivers from the transmitter and providing the time difference to the positioning unit.

Preferably, but not necessarily, the position signal transmitted from the transmitter includes a position signal of RF band (RF position signal).

Preferably, but not necessarily, the receiver includes an antenna receiving the RF position signal transmitted by the transmitter, and a converter converting the RF position signal to a position signal of IF frequency band (IF position signal).

Preferably, but not necessarily, the gateway includes a plurality of modems receiving each position signal from the plurality of receivers; a clock unit providing clocks; and a measurement unit measuring a TDOA using a reception time of the position signal in the plurality of modems based on the clock provided by the clock unit.

Preferably, but not necessarily, the TDOA includes a difference between an arrival time of position signal at the receiver and a transmission time of position signal at the transmitter.

Preferably, but not necessarily, the plurality of receivers and the plurality of modems are wiredly connected.

Preferably, but not necessarily, the plurality of receivers and the plurality of modems are connected via a predetermined cable.

Preferably, but not necessarily, the TDOA includes a difference of reception time of position signal at modem and delay time predetermined by the signal transmission characteristic of the cable.

Preferably, but not necessarily, the gateway further comprises a signal processor decoding the position signal received by the plurality of modems.

Preferably, but not necessarily, the transmitter and the plurality of receivers form a positioning group, and the plurality of receivers in the positioning group receive the position signal transmitted by the transmitter in the positioning group.

The RTLS system using TDOA according to the present disclosure has an advantageous effect in that time synchronization of reception period is not needed in a TDOA-based RTLS system to enable a simplified structure of the TDOA-based RTLS system, and an accurate time difference in which a signal arrives from a transmitter can be calculated in a gateway existing in a positioning group unit.

Another advantage is that the receiver in the RTLS system according to the present disclosure performs to convert an RF position signal to an IF position signal only, whereby structure of the receiver of the RTLS system can be simplified and an accurate time measurement can be enabled by forming a local clock unit at each gateway.

### BRIEF DESCRIPTION OF THE DRAWINGS

In order to explain the principle of the present disclosure, some accompanying drawings related to its preferred embodiments are below reported for the purpose of illustration, exemplification and description, although they are not intended to be exhaustive. The drawing figures depict one or more exemplary embodiments in accord with the present concepts, by way of example only, not by way of limitations. In the figures, like reference numerals refer to the same or similar elements.

Thus, a wide variety of potential practical and useful embodiments will be more readily understood through the following detailed description of certain exemplary embodiments, with reference to the accompanying exemplary drawings in which:

FIG. 1 is a schematic conceptual view illustrating a conventional TDOA-based RTLS system, where FIG. 1 illustrates a time synchronization of a reception period using an optical communication network;

FIG. 2 is a schematic conceptual view illustrating a conventional TDOA-based RTLS system, where FIG. 2 illustrates a time synchronization of a reception period using a wireless communication network;

FIG. 3 is a block diagram illustrating an exemplary detailed configuration of FIG. 1;

FIG. 4 is a schematic view illustrating an RTLS system according to an exemplary embodiment of the present disclosure; and

FIG. 5 is a structural view illustrating a detailed configuration of the RTLS system of FIG. 4.

### DETAILED DESCRIPTION

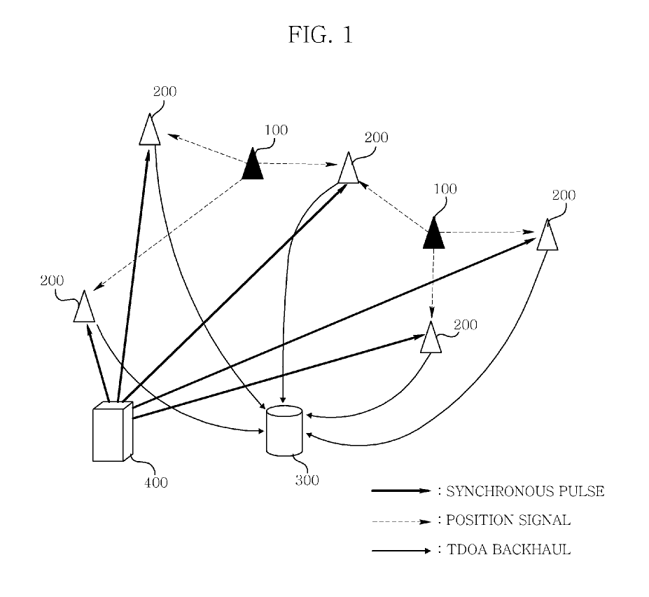

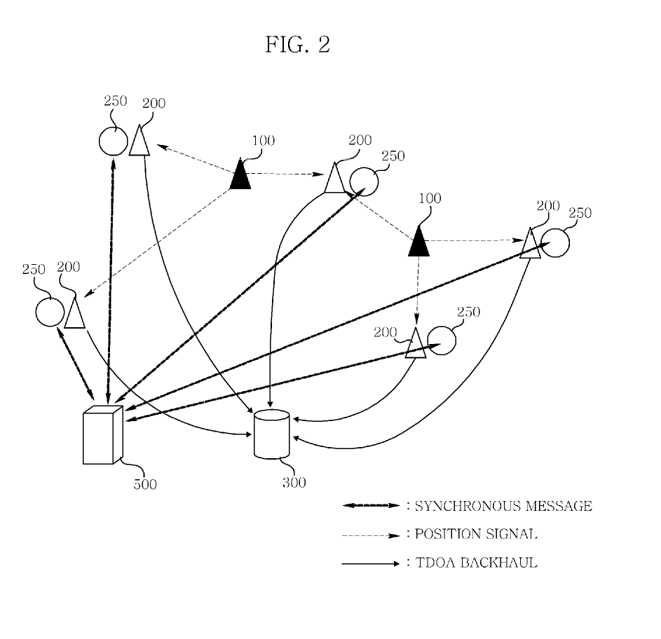

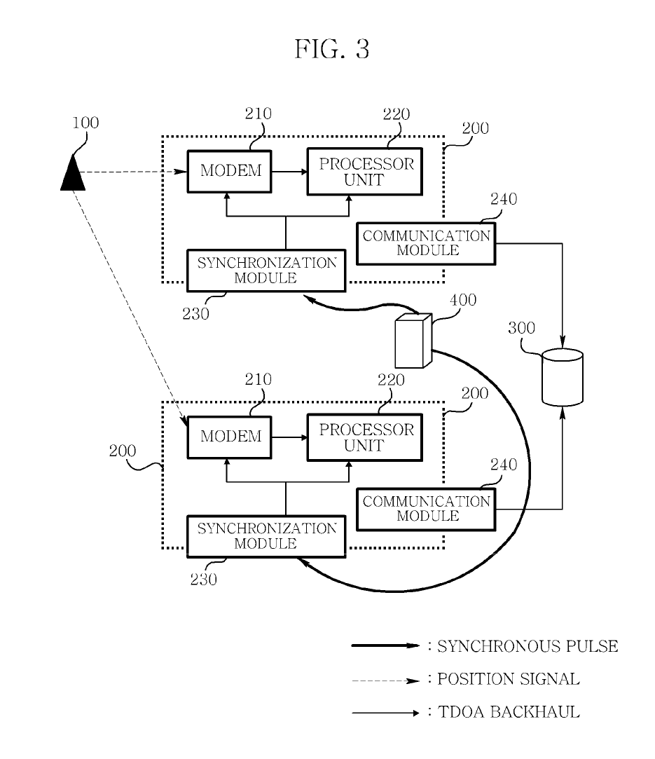

The disclosed embodiments and advantages thereof are best understood by referring to FIGS. 1-5 of the drawings, like numerals being used for like and corresponding parts of the various drawings. Other features and advantages of the disclosed embodiments will be or will become apparent to one of ordinary skill in the art upon examination of the following figures and detailed description. It is intended that all such additional features and advantages be included within the scope of the disclosed embodiments, and protected by the accompanying drawings. Further, the illustrated figures are only exemplary and not intended to assert or imply any limitation with regard to the environment, architecture, or process in which different embodiments may be implemented. Accordingly, the described aspect is intended to embrace all such alterations, modifications, and variations that fall within the scope and novel idea of the present invention.

Meanwhile, the terminology used herein is for the purpose of describing particular implementations only and is not intended to be limiting of the present disclosure. The terms “first,” “second,” and the like, herein do not denote any order, quantity, or importance, but rather are used to distinguish one element from another. For example, a second constituent element may be denoted as a first constituent element without departing from the scope and spirit of the present disclosure, and similarly, a first constituent element may be denoted as a second constituent element.

As used herein, the terms “a” and “an” herein do not denote a limitation of quantity, but rather denote the presence of at least one of the referenced item. That is, as used herein, the singular forms “a”, “an” and “the” are intended to include the plural forms as well, unless the context clearly indicates otherwise.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof

Also, “exemplary” is merely meant to mean an example, rather than the best. If is also to be appreciated that features, layers and/or elements depicted herein are illustrated with particular dimensions and/or orientations relative to one another for purposes of simplicity and ease of understanding, and that the actual dimensions and/or orientations may differ substantially from that illustrated.

That is, in the drawings, the size and relative sizes of layers, regions and/or other elements may be exaggerated or reduced for clarity. Like numbers refer to like elements throughout and explanations that duplicate one another will be omitted. As may be used herein, the terms “substantially” and “approximately” provide an industry-accepted tolerance for its corresponding term and/or relativity between items.

Hereinafter, an RTLS system using TDOA according to the present disclosure will be described in detail with reference to the accompanying drawings.

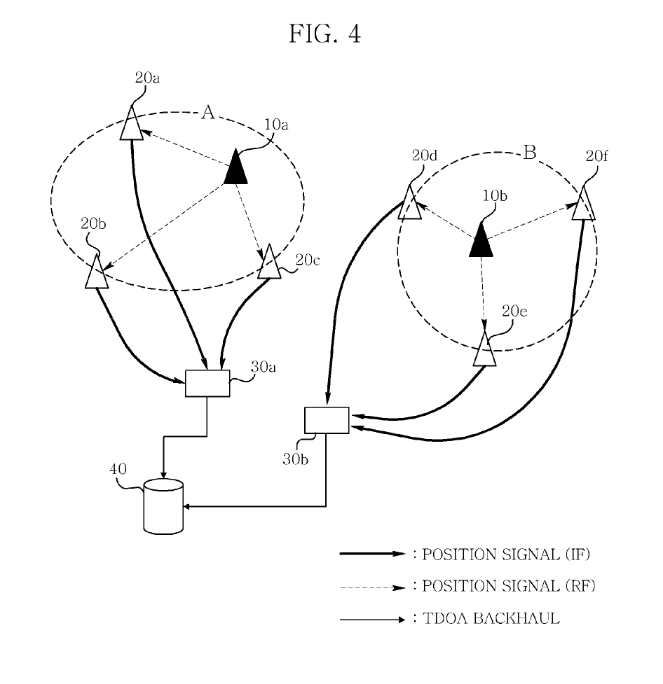

FIG. 4 is a schematic view illustrating an RTLS system according to an exemplary embodiment of the present disclosure.

Referring to FIG. 4, an RTLS system using TDOA according to the present disclosure comprises a plurality of RTLS transmitters (hereinafter referred to as transmitter, 10), a plurality of RTLS receivers (hereinafter referred to as receivers, 20), a plurality of RTLS gateways (hereinafter referred to as gateway, 30) and an RTLS positioning unit (hereinafter referred to as positioning unit, 40).

In the present disclosure, one transmitter 10 and a predetermined number of receivers 20 (three receivers in FIG. 4) form a positioning group, where one positioning group corresponds to one gateway 30. One transmitter 10 in one positioning group in the present disclosure transmits a position signal to only receivers 20 in the positioning group.

For convenience of description, FIG. 4 illustrates that a transmitter in positioning group A is ‘10a’, receivers in positioning group A are ‘20a˜20c’ and a gateway corresponding to the positioning group A is ‘30a’. Furthermore, a transmitter in positioning group B is ‘10b’, receivers in positioning group B are ‘20d˜20f’ and a gateway corresponding to the positioning group B is ‘30b’. It should be apparent however that these designations are arbitrarily provided just for convenience sake, such that the number of positioning groups, the number of receivers in the positioning group and the number of gateways may be determined in accordance with necessity, and these designations and numbers are not limited thereto.

The transmitter 10 transmits a position signal including its own information in the form of an RF (Radio Frequency) to the receiver 20. The receiver 20 converts the RF position signal from the transmitter 10 to a signal of an IF (Intermediate Frequency) band and wiredly transmits the signal to the gateway 30.

The gateway 30 receives the IF position signal from the receiver 20, records a point where the IF position signal is received, and transmits a relevant time information to the positioning unit 40. The positioning unit 40 receives the time information from the gateway 30 and determines a position of the transmitter 10 using the time information.

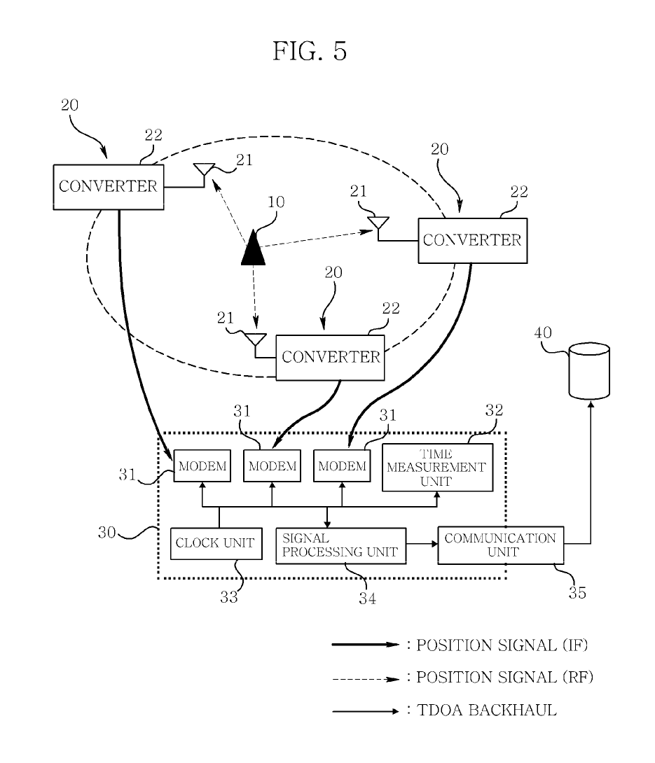

FIG. 5 is a structural view illustrating a detailed configuration of the RTLS system of FIG. 4, where each detailed configuration of receiver 20 and gateway 30 is provided.

Referring to FIG. 5, the receiver 20 according to the present disclosure includes an antenna 21 and a converter 22. Other detailed configurations will be omitted in description thereof, because these configurations are obvious to the skilled in the art.

The antenna 21 receives the RF position signal transmitted by the transmitter 10, and the converter 22 converts the RF position signal transmitted by the transmitter 10 to an IF position signal of IF frequency band. The IF frequency band converted by the converter 22 is determined by frequency transmission characteristics of a cable connected to the receiver 20 and the gateway 30.

The gateway 30 according to the present disclosure comprises a modem 31 receiving a signal from the receiver 20, a time measurement unit 32, a clock unit 33, a signal processor unit 34 and a communication unit 35. As in the receiver 20 above, other detailed configurations of gateway 30 than what is described above will be omitted in description thereof, because these configurations are obvious to the skilled in the art.

Each receiver 20 in the positioning group is connected to the gateway 30 by way of a cable, and the converter 22 converts the RF position signal from the transmitter 10 to an IF frequency signal and transmits the converted IF frequency signal to the gateway 30.

The gateway 30 includes a modem 31 corresponding to the receiver 20. Although FIG. 5 describes that one modem 31 is correspondingly included in one receiver 20 and each modem 31 receives a position signal of IF frequency band from the corresponding receiver 20, the configuration is not limited to what is shown in FIG. 5, such that a configuration in which one modem receiving signals from a plurality of channels is formed to receive all the position signals of IF frequency band received from a plurality of receivers 20 cannot be ruled out.

The position measurement of the transmitter 10 in the TDOA based-RTLS system is based on a time difference of arrival by a position signal transmitted by the transmitter 10 to the plurality of receivers 20 about the transmitter 10. Thus, a length of a cable between each of the plurality of receivers 20 and the gateway 30 is basically same, but in a case the length has to be differentiated depending on circumstances, delay of position signal of receiver 20 is compensated as much as a difference of the cable length.

The signal processor unit 34 in FIG. 5 serves to decode the IF position signal received by each modem 31 (that is, analogue signal is restored or coded to a digital signal). The signal processor unit 34 can learn a reception time of signal from each modem 31 based on a clock provided by the clock unit 33, and provide the reception time to the time measurement unit 32. The time measurement unit 32 determines a difference between the reception time and transmission time using the following equation.

“Arrival time of position signal at the receiver−transmission time of position signal from transmitter=reception time of position signal at modem−delay time” [Equation 1]

where the delay time is predetermined by the signal transmission characteristic of cable.

The communication unit 35 transmits the TDOA thus determined to the positioning unit 40. The positioning unit 40 locates the transmitter 10 based on the received TDOA, the detailed configuration of which is well known in the art, and is omitted in further description thereto.

The TDOA-based RTLS system according to the present disclosure has an industrial applicability in that a clock is provided from the gateway by itself to remove the clock drift of reception period that is generated by independent usage of oscillator by each receiver according to the prior art, and no separate device is required to the receiver for time synchronization of reception period to thereby simplify the configuration of the system.

Although the present disclosure has been described with reference to a number of illustrative embodiments thereof, it should be understood that numerous other modifications and embodiments can be devised by those skilled in the art that will fall within the spirit and scope of the principles of this disclosure.

More particularly, various variations and modifications are possible in the component parts and/or arrangements of subject combination arrangement within the scope of the disclosure, the drawings and the appended claims. In addition to variations and modifications in the component parts and/or arrangements, alternative uses will also be apparent to those skilled in the art.

What is claimed is:

1. An RTLS system tracking, by a positioning unit, a position of a transmitter based on a position signal transmitted by the transmitter, the system comprising: a plurality of receivers receiving the position signal from the transmitter; and a gateway calculating a time difference of position signal arriving at the plurality of receivers from the transmitter and providing the time difference to the positioning unit.

2. The system of claim 1, wherein the position signal transmitted from the transmitter includes a position signal of RF band (RF position signal).

3. The system of claim 2, wherein the receiver comprises an antenna receiving the RF position signal transmitted by the transmitter, and a converter converting the RF position signal to a position signal of IF frequency band (IF position signal).

4. The system of claim 1, wherein the gateway comprises a plurality of modems receiving each position signal from the plurality of receivers; a clock unit providing clocks; and a measurement unit measuring a TDOA using a reception time of the position signal in the plurality of modems based on the clock provided by the clock unit.

5. The system of claim 4, wherein the TDOA includes a difference between an arrival time of position signal at the receiver and a transmission time of position signal at the transmitter.

6. The system of claim 4, wherein the plurality of receivers and the plurality of modems are wiredly connected.

7. The system of claim 4, wherein the plurality of receivers and the plurality of modems are connected via a predetermined cable.

8. The system of claim 7, wherein the TDOA includes a difference of reception time of position signal at modem and delay time predetermined by the signal transmission characteristic of the cable.

9. The system of claim 4, wherein the gateway further comprises a signal processor decoding the position signal received by the plurality of modems.

10. The system of claim 1, wherein the transmitter and the plurality of receivers form a positioning group, and the plurality of receivers in the positioning group receive the position signal transmitted by the transmitter in the positioning group.
